(19) United States
(12) Patent Application Publication
(10) Pub. No.: US 2008/0260040 A1
(43) Pub. Date: Oct. 23, 2008

(54) METHOD, DEVICE, INTEGRATED CIRCUIT AND ENCODER FOR FILTERING VIDEO NOISE

(75) Inventors: Yen-I OUYANG, Taipei (TW); Hiroyori MORIMOTO, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/876,122

(22) Filed: Oct. 22, 2007

(30) Foreign Application Priority Data
Oct. 24, 2006 (JP) 2006-288399

(51) Int. Cl. H04N 7/24

(52) U.S. Cl. 375/240.24; 375/E07.011

(57) ABSTRACT

A method for filtering video noise is adapted to filter noise of a plurality of images of a video stream. Each image includes a plurality of pixels. The method includes the following steps: (a) dividing an image into a plurality of macroblocks; (b) classifying the macroblocks into a plurality of smooth macroblocks and a plurality of noisy macroblocks, and outputting the pixels of the smooth macroblocks; (c) classifying the pixels of each noisy macroblock into an edge pixel group and a non-edge pixel group; (d) directing the non-edge pixel group to a spatial vertical filtering and subsequently to a temporal filtering; and (e) directing the yet to be outputted pixels to a spatial horizontal filtering and subsequently outputting the same. Also disclosed are a device, an integrated circuit and an encoder for filtering video noise.

### BACKGROUND OF THE INVENTION

1. Field of the Invention

The invention relates to a method, device, integrated circuit and encoder for processing video noise, and more particularly to a method, device, integrated circuit, and encoder for filtering video noise.

2. Description of the Related Art

Most conventional video noise filtering methods provide a suitable filter based on a statistical value that can represent a feature of an image, and then filter all the pixels in the image. However, for the image generally can be further divided into regions having different detail features, if all the pixels in the image are filtered using the same filter, the objectives of filtering noise and preserving image details cannot be met. In many examples, the detail features on edges and in texture regions of the image will also be lost while during the operations of filtering noise, which causes the image overly blurred. Besides, filtering all the pixels in the image generally requires an extremely large amount of computation.

Another conventional video noise filtering method is a detail preserving noise filtering method (hereinafter referred to as the DPNF method) disclosed in U.S. Pat. No. 5,818,964, which can be used to filter regions of heterogeneous features in an image to achieve the objectives of filtering noise and preserving image details.

Referring to FIG. 1, in the DPNF method, the image is first divided into a plurality of blocks. Then, an index generating unit 1 is used to generate a plurality of binary indexes. Finally, according to the binary indexes, a selective local smoothing unit 2 is used to perform suitable filtering in regions of heterogeneous features in the image, respectively.

The index generating unit 1 includes a threshold determining unit 11 and a binary index unit 12. First, the threshold determining unit 11 finds a binary threshold value based on the gray level values of a plurality of pixels in each block. Then, the binary index unit 12 compares the gray level value of every pixel in each block with the binary threshold value. If the gray level value of a pixel is greater than the binary threshold value, a binary index value corresponding to the pixel is set to 1. Otherwise, the binary index value is set to 0. A binary index block 3 such as that shown in FIG. 2 can be obtained for each block.

The selective local smoothing unit 2 includes a filter selecting unit 21 and an adaptive filtering unit 22. First, the filter selecting unit 21 provides a window 31 of a predetermined size in the binary index blocks 3 and, according to the binary indexes in the window 31, determines the regions into which the pixels are categorized. If all the binary indexes in the window 31 are the same, i.e., all are “0”s or all are “1”s, the pixel 32 at the central position of the window 31 is categorized into a homogeneous region. Otherwise, the pixel 33 at the central position of the window 31 is categorized into a heterogeneous region. Then, the adaptive filtering unit 22 selects a suitable filter according to the region to which the pixels belong for filtering.

Although the DPNF method can filter video noise while preserving image details, it is still necessary to filter all the pixels in the image with the DPNF method, which leaves little space for improvement in terms of computational efficiency. Therefore, there is still room for improving the conventional methods.

### SUMMARY OF THE INVENTION

Therefore, an object of the present invention is to provide a method for filtering video noise.

Accordingly, the method for filtering video noise of the present invention is adapted for filtering noise of a plurality of images of a video stream. Each image includes a plurality of pixels. The method includes the following steps: (a) selecting an image and dividing the image into a plurality of macroblocks, each macroblock having a plurality of blocks; (b) classifying the macroblocks into a plurality of smooth macroblocks and a plurality of noisy macroblocks, and outputting the pixels of the smooth macroblocks; (c) classifying the pixels of each noisy macroblock into an edge pixel group and a non-edge pixel group; (d) directing the non-edge pixel group to a spatial vertical filtering and subsequently to a temporal filtering; and (e) directing the yet to be outputted pixels to a spatial horizontal filtering and subsequently outputting the same.

Therefore, another object of the present invention is to provide a device for filtering video noise.

Accordingly, the device for filtering video noise of the present invention is adapted for filtering noise of a plurality of images of a video stream. Each image includes a plurality of pixels. The device includes a macroblock filtering unit, an edge/non-edge pixel classifying unit, and a filtering unit. The macroblock filtering unit selects an image, divides the image into a plurality of macroblocks, each macroblock having a plurality of blocks, subsequently classifies the macroblocks into a plurality of smooth macroblocks and a plurality of noisy macroblocks, and outputs pixel values of the smooth macroblocks. The edge/non-edge pixel classifying unit classifies the pixels of each noisy macroblock into an edge pixel group and a non-edge pixel group. The filtering unit includes a spatial vertical filter, a temporal filter, and a spatial horizontal filter. The non-edge pixel group is first directed to the processing of the spatial vertical filter and then to the processing of the temporal filter. The pixels yet to be outputted are processed by the spatial horizontal filter for subsequent output.

Therefore, still another object of the present invention is to provide an integrated circuit for filtering video noise.

Accordingly, the integrated circuit for filtering video noise of the present invention is adapted for filtering noise of a plurality of images of a video stream. Each image includes a plurality of pixels. The integrated circuit includes a macroblock filtering unit, an edge/non-edge pixel classifying unit, and a filtering unit. The macroblock filtering unit selects an image, divides the image into a plurality of macroblocks, each macroblock having a plurality of blocks, classifies the macroblocks into a plurality of smooth macroblocks and a plurality of noisy macroblocks, and outputs pixel values of the smooth macroblocks. The edge/non-edge pixel classifying unit classifies the pixels of each noisy macroblock into an edge pixel group and a non-edge pixel group. The filtering unit includes a spatial vertical filter, a temporal filter, and a spatial horizontal filter. The non-edge pixel group is first directed to the processing of the spatial vertical filter and then to the processing of the temporal filter. The pixels yet to be outputted are processed by the spatial horizontal filter for subsequent output.

Therefore, yet another object of the present invention is to provide an encoder for filtering video noise.

Accordingly, the encoder for filtering video noise of the present invention is adapted for filtering noise and for encoding video. The encoder includes an image input unit, a device for filtering video noise, a memory unit, and a video encoding unit.

The image input unit receives and inputs a video stream including a plurality of images. Each image has a plurality of pixels. The device for filtering video noise includes a macroblock filtering unit, an edge/non-edge pixel classifying unit, and a filtering unit. The macroblock filtering unit divides an image into a plurality of macroblocks having a plurality of blocks, subsequently classifies the macroblocks into a plurality of smooth macroblocks and a plurality of noisy macroblocks, and outputs pixel values of the smooth macroblocks. The edge/non-edge pixel classifying unit classifies the pixels of each noisy macroblock into an edge pixel group and a non-edge pixel group. The filtering unit has a spatial vertical filter, a temporal filter, and a spatial horizontal filter. The non-edge pixel group is first directed to the processing of the spatial vertical filter, and then to the processing of the temporal filter. The pixels yet to be outputted are processed by the spatial horizontal filter for subsequent output. The memory unit temporarily stores the macroblocks outputted by the device for filtering video noise. The video encoding unit reads and encodes the macroblocks temporarily stored in the memory unit.

The present invention does not require filtering of all the pixels in the image. Only the pixels of the noisy macroblocks are classified and directed to suitable filtering processing. This not only can enhance computational efficiency but also can filter noise of images while preserving image details, thereby achieving the objects of the present invention.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram to illustrate a conventional method for filtering video noise;

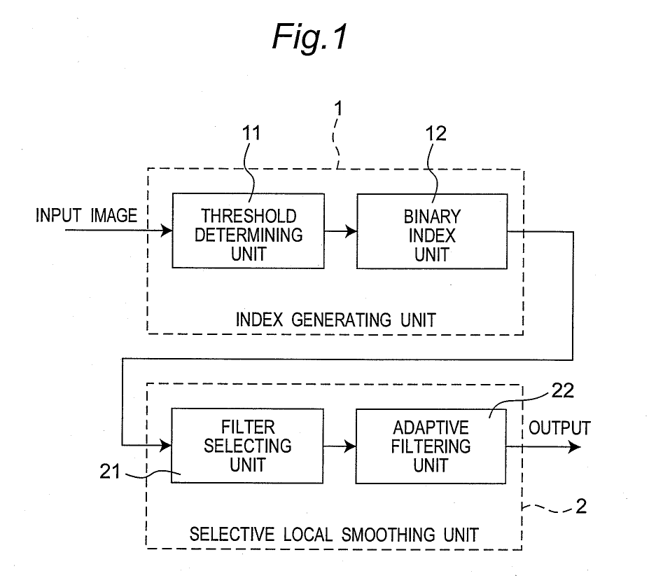

FIG. 2 is a schematic diagram of the conventional method to illustrate how a suitable filter is selected according to a binary index block and a window;

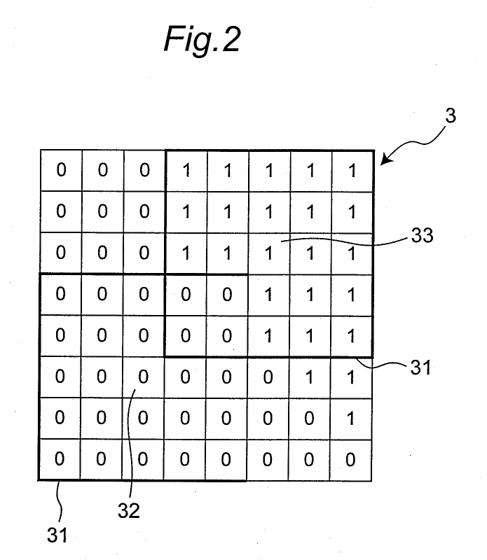

FIG. 3 is a block diagram to illustrate a preferred embodiment of an encoder for filtering video noise according to the present invention;

FIG. 4 is a block diagram to illustrate a preferred embodiment of a device for filtering video noise according to the present invention;

FIG. 5 is a flowchart to illustrate a preferred embodiment of a method for filtering video noise according to the present invention;

FIG. 6 is a schematic diagram to illustrate how pixels are classified and how a suitable filter is selected according to a binarization block and a sliding window in the method of the present invention; and

FIG. 7 is a schematic diagram to illustrate a current image and a previous image in a video stream.

### DETAILED DESCRIPTION OF THE PREFERRED EMBODIMENT

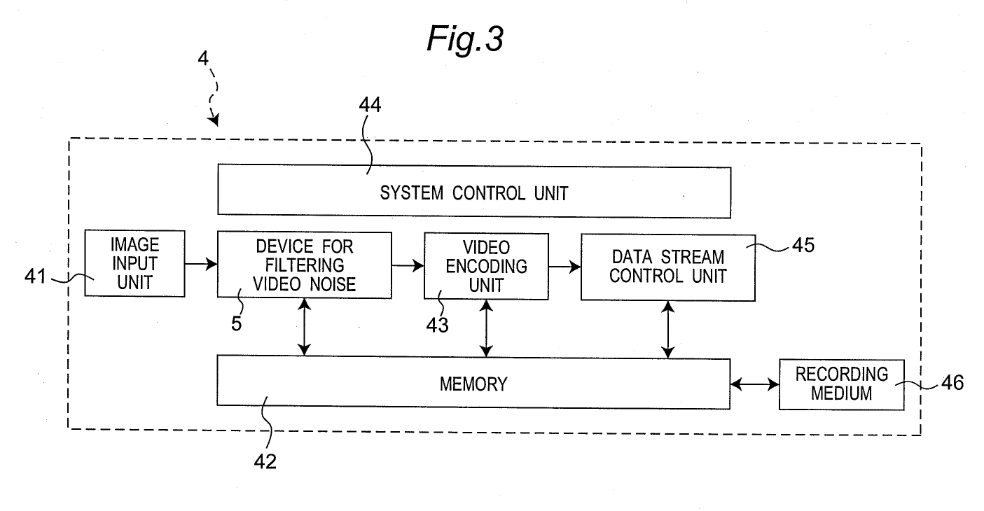

Referring to FIG. 3, the preferred embodiment of an encoder 4 for filtering video noise according to the present invention is adapted for filtering noise and for encoding video. The encoder 4 includes an image input unit 41, a device 5 for filtering video noise, a memory unit 42, a video encoding unit 43, a system control unit 44, a data stream control unit 45, and a recording medium 46.

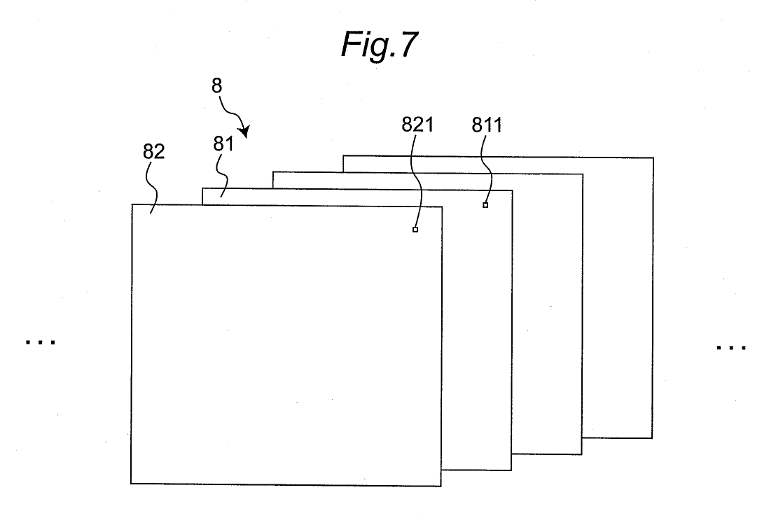

Referring to FIGS. 3 and 7, the image input unit 41 is used to receive and input a video stream 8 that includes a plurality of images. Each image has a plurality of pixels. The device 5 for filtering video noise is used to filter noise of the images of the video stream. The memory unit 42 is used to temporarily store an output from the device 5 for filtering video noise. The video encoding unit 43 is used to read the output of the device 5 for filtering video noise as temporarily stored in the memory unit 42, and performs compression/encoding thereupon before storing the same back into the memory unit 42. The system control unit 44 is used to control the overall operational process of all the units and devices within the encoder 4. The data stream control unit 45 is used to control storage of compressed/encoded data streams from the memory unit 42 to the recording medium 46. In this preferred embodiment, the image input unit 41 is a camera. The recording medium 46 can be a secure digital card (SD), a digital versatile disk (DVD), a Blu-ray disk (BD), or a hard disk drive (HDD). The data stream control unit 45 functions like a multiplexer, and is used to store the data streams in the memory unit 42 into the aforesaid SD, DVD, BD or HDD, and to perform output processing in corresponding format.

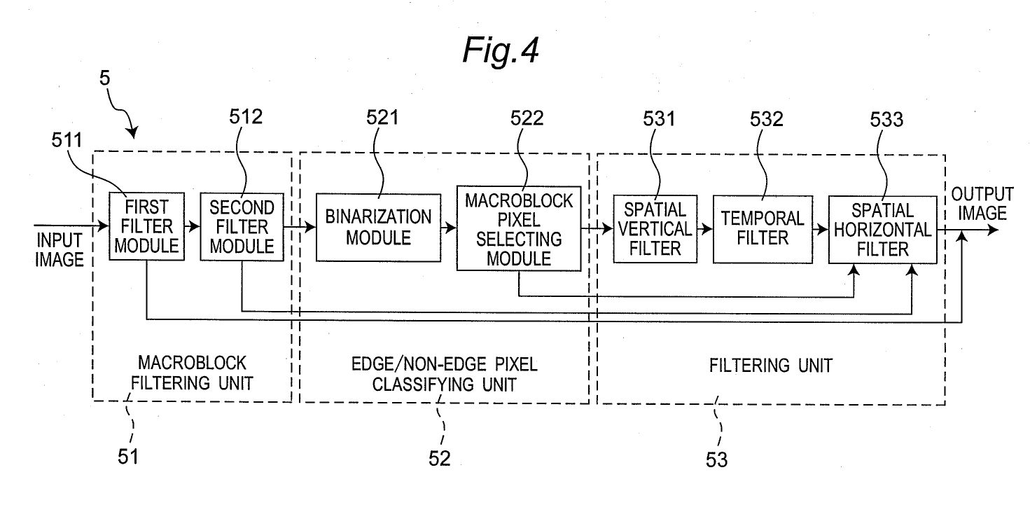

As shown in FIG. 4, the device 5 for filtering video noise includes a macroblock filtering unit 51, an edge/non-edge pixel classifying unit 52, and a filtering unit 53. The macroblock filtering unit 51 has a first filter module 511 and a second filter module 512. The edge/non-edge pixel classifying unit 52 has a binarization module 521 and a macroblock pixel selecting module 522. The filtering unit 53 has a spatial vertical filter 531, a temporal filter 532, and a spatial horizontal filter 533.

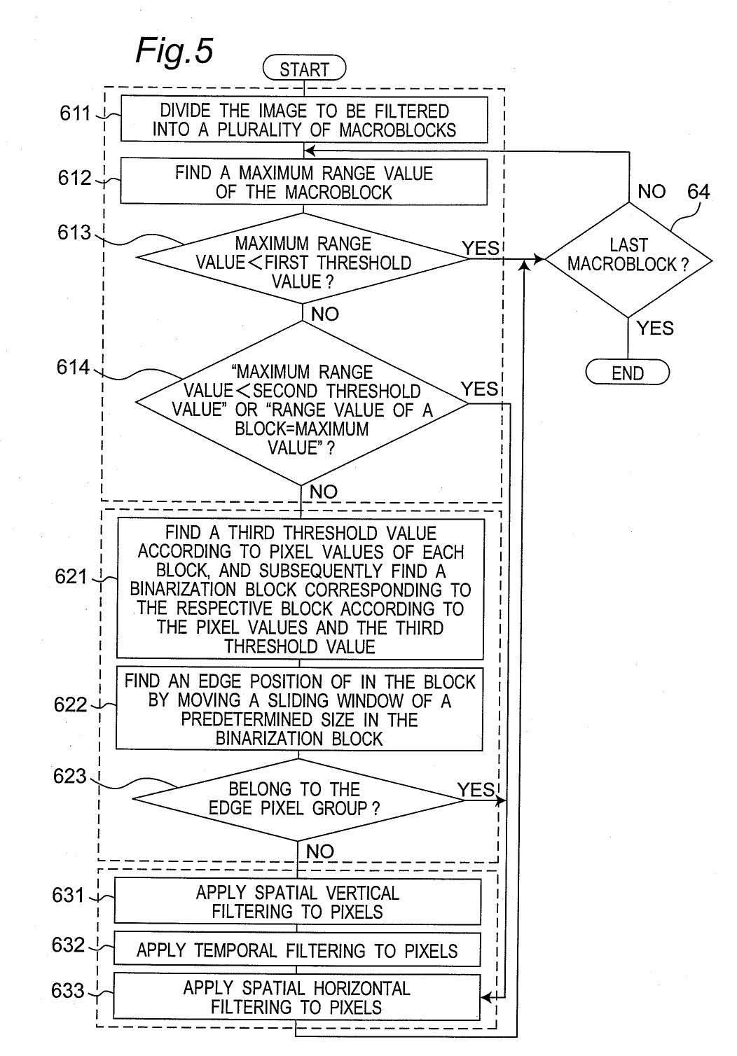

Referring to FIGS. 3 to 6, in steps 611 to 613, the first filter module 511 is used to first select an image to be filtered, and to divide the image into a plurality of macroblocks (MB) 7. Each macroblock 7 has a plurality of blocks 71. Then, respective range values of the blocks 71 in the macroblock 7 are found, and the largest range value of the blocks 71 in the macroblock 7 is used as a maximum range value. Finally, it is determined whether the maximum range value is smaller than a predetermined first threshold value thr₁. If yes, the macroblock 7 is classified as a smooth macroblock, and the pixels thereof are outputted to the memory unit 42. Otherwise, the macroblock 7 is classified as a noisy macroblock, and is directed to the following processing. In this preferred embodiment, each macroblock 7 has six blocks 71. The range value of each block 71 is the difference between a maximum pixel value and a minimum pixel value of the block 71.

In step 614, the second filter module 512 is used to execute the following determinations:

If the maximum range value of each noisy macroblock is smaller than a predetermined second threshold value thr₂, the pixels of the noisy macroblock are soon directed to the processing in step 633. Alternatively, if the range value of any one of the blocks 71 of the noisy macroblock is equal to the maximum range value of the noisy macroblock, the pixels of the respective block 71 are soon directed to the processing in step 633.

In step 621, the binarization module 521 is used to find a third threshold value thr₃ according to a plurality of pixel values P(i,j) of each block 71, and to find a binarization block 72 corresponding to the respective block 71 according to the pixel values P(i,j) and the third threshold value thr₃, the binarization block 72 having a plurality of binary values bin(i,j), which can be expressed as follows:

$${thr}_{3} = \frac{{\sum }_{j = 0}^{j < blk\_h} {\sum }_{i = 0}^{i < blk\_w} P ( i , j )}{blk\_h \times blk\_w} \{ \begin{matrix}If P ( i , j ) > {thr}_{3} , & then bin ( i , j ) = 1 \\ Otherwise , & bin ( i , j ) = 0\end{matrix}$$

where blk_w and blk_h respectively represent the width and height of the block 71. In this preferred embodiment, blk_w=blk_h=8.

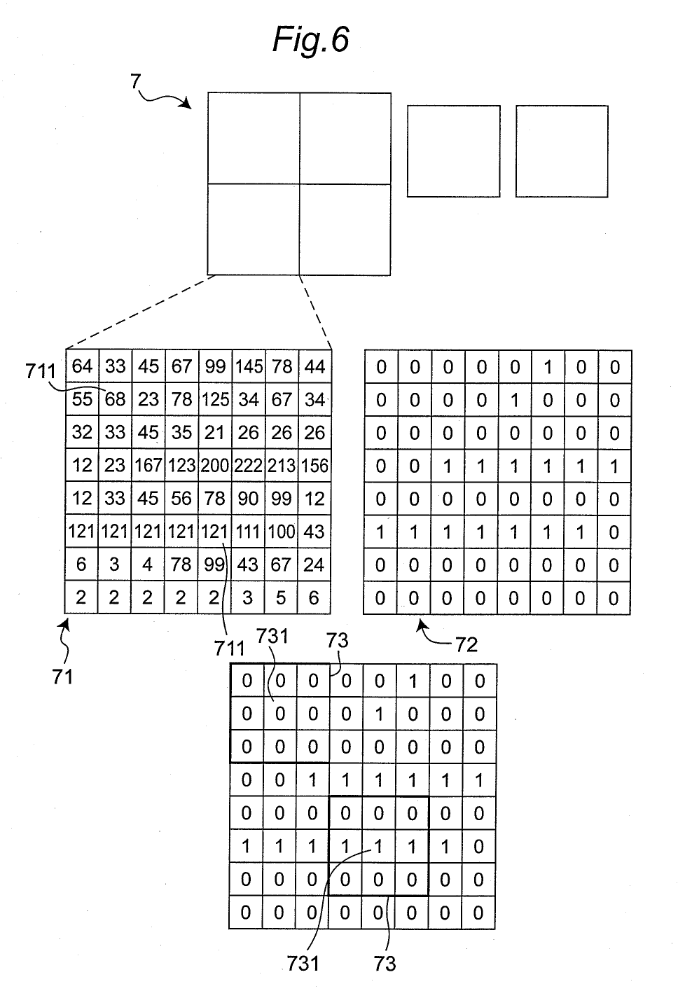

In step 622, the macroblock pixel selecting module 522 finds an edge position in the block 71 by moving a sliding window 73 of a predetermined size in the binarization block 72. As shown in FIG. 6, the size of the sliding window 73 is 3×3, and the sliding window 73 moves one pixel at one time. If all the binary values bin(i,j) in the sliding window 73 are the same, e.g., all are 0's or all are 1's the corresponding pixel 711 at a central position 731 in the sliding window 73 is not located on an edge, and belongs to a non-edge pixel group. Otherwise, the corresponding pixel 711 at the central position 731 in the sliding window 73 is located on an edge, and belongs to an edge pixel group.

In step 623, if the corresponding pixel 711 belongs to the edge pixel group, the processing in step 633 is directly performed. Otherwise, the following processing is performed.

In steps 631 to 633, the non-edge pixel group is first directed to the processing of the spatial vertical filter 531. The spatial vertical filter 531 is a 3-tap finite impulse response (FIR) filter. A coefficient set of the 3-tap FIR is (Coeffᵤₚ, Coeff_{target}_{_{—}}ᵥ, Coeff_{down}). The pixel value P_{target}_{_{—}}ᵥ(i,j) after filtering can be expressed as follows:

P_{target}_{_{—}}ᵥ(i,j)=P(i,j−1)×Coeffᵤₚ+P(i,j)×Coeff_{target}_{_{—}}ᵥ+P(i,j+1)×Coeff_{down}

Referring to FIGS. 4, 5 and 7, the temporal filter 532 is subsequently used to find a new pixel value P_{new}(i,j) using a predetermined ratio according to the pixel values of the corresponding positions 811, 821 in an image 81 and a previous image 82. If the absolute value of the difference between the pixel value of the position 811 in the image 81 and the new pixel value P_{new}(i,j) is smaller than a fourth threshold value thr₄, the pixel value of the position 811 is substituted and updated by the new pixel value P_{new}(i,j) which can be expressed as follows:

P_{new}(i,j)=Pᵢ(i,j)×W₁+Pₜ₋₁(i,j)×W₂
If (|Pₜ(i,j)−P_{new}(i,j)|<thr₄), then, Pₜ(i,j)=P_{new}(i,j), Otherwise Pₜ(i,j)=Pₜ(i,j)
   where Pₜ(i,j) and Pₜ₋₁(i,j) respectively represent the pixel values of the positions 811 and 821, and (W₁,W₂) is the predetermined ratio. In this preferred embodiment, W₁=0.75 and W₂=0.25.

Referring to FIGS. 3, 4 and 5, finally, the pixels yet to be outputted are processed by the spatial horizontal filter 533 and subsequently outputted to the memory unit 42. In this preferred embodiment, the spatial horizontal filter 533 can have filters of different coefficients with respect to gray data and color data of the image, which are, respectively, a 15-tap FIR for the gray data, and a 7-tap FIR filter for the color data.

Take the 7-tap FIR filter as an example. The coefficient set of that filter is (Coeff_{left3}, Coeff_{left2}, Coeff_{left1}, Coeff_{target}_{_{—}}ₕ, Coeff_{right1}, Coeff_{right2}, Coeff_{right3}), and the pixel value P_{target}_{_{—}}ₕ(i,j) after filtering can be expressed as follows:

P_{target}_{_{—}}ₕ(i,j)=P(i−3,j)×Coeff_{left3}+P(i−2,j)×Coeff_{left2}+P(i−1,j)×Coeff_{left1}+P(i,j)×Coeff_{target}_{_{—}}ₕ+P(i+1,j)×Coeff_{right1}+P(i+2,j)×Coeff_{right2}+P(i+3,j)×Coeff_{right3}

In step 64, it is determined whether each macroblock 7 (see FIG. 6) of the image has undergone the processing in the aforesaid steps. If yes, noise filtering processing of the image has been completed. Otherwise, the flow returns to step 612. After undergoing the processing in the aforesaid steps, each macroblock 7 is temporarily stored in the memory unit 42, and the video encoding unit 43 is used to compress/encode the macroblock 7.

In addition, the integrated circuit for filtering video noise according to the present invention includes the macroblock filtering unit 51, the edge/non-edge pixel classifying unit 52, and the filtering unit 53 shown in FIG. 4. The macroblock filtering unit 51 and the edge/non-edge pixel classifying unit 52 can constitute a macroblock classifying integrated circuit. The filtering unit 53 can constitute a macroblock filtering integrated circuit. Such combinations can also achieve similar effects.

In sum, the method, the device, the integrated circuit, and the encoder for filtering video noise have the following advantages. First, the macroblocks are classified into smooth macroblocks and noisy macroblocks, and the smooth macroblocks are outputted without undergoing processing. Under normal conditions, about 70% of the macroblocks do not need to go through subsequent noise filtering processing (either full or partial). Therefore, computational efficiency can be enhanced. Second, by further classifying the pixels of the noisy macroblocks, and by providing a suitable spatial vertical filter, temporal filter, or spatial horizontal filter to perform filtering, video noise can be filtered while preserving image details. Therefore, the objects of the present invention can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for filtering video noise adapted to filter noise of a plurality of images of a video stream, each image including a plurality of pixels, said method comprising the following steps:
(a) selecting an image and dividing the image into a plurality of macroblocks, each macroblock having a plurality of blocks;
(b) classifying the macroblocks into a plurality of smooth macroblocks and a plurality of noisy macroblocks, and outputting the pixels of the smooth macroblocks;
(c) classifying the pixels of each noisy macroblock into an edge pixel group and a non-edge pixel group;
(d) directing the non-edge pixel group to a spatial vertical filtering and subsequently to a temporal filtering; and
(e) directing the yet to be outputted pixels to a spatial horizontal filtering and subsequently outputting the same.

2. The method according to claim 1, wherein step (b) includes the following sub-steps:
(b-1) finding a range value of each block of the macroblocks, wherein the range value of each block is the difference between a maximum pixel value and a minimum pixel value of the block, and subsequently finding a maximum range value of each macroblock according to the range values; and
(b-2) determining whether the maximum range value is smaller than a predetermined first threshold value and, if yes, classifying the corresponding macroblock as a smooth macroblock and outputting the pixels thereof, and otherwise classifying the corresponding macroblock as a noisy macroblock.

3. The method according to claim 2, wherein step (b) further includes the following sub-steps:
(b-3) if the maximum range value of each noisy macroblock is smaller than a predetermined second threshold value, soon directing the pixels of the corresponding macroblock to the processing in step (e); and
(b-4) if the range value of any one block of the noisy macroblock is equal to the maximum range value of the noisy macroblock, soon directing the pixels of said block to the processing in step (e).

4. The method according to claim 1, wherein step (c) further includes the following sub-steps:
(c-1) finding a third threshold value according to a plurality of pixel values in each block, and subsequently finding a binarization block corresponding to the respective block according to the pixel values and the third threshold value; and
(c-2) by moving a sliding window of a predetermined size in the binarization block, finding an edge position in the respective block, and subsequently classifying the pixels at the edge position in the respective block into the edge pixel group, and the remaining pixels in the respective block into the non-edge pixel group.

5. The method according to claim 1, wherein the temporal filtering in step (d) includes the following sub-steps:
(d-1) according to a plurality of pixel values of corresponding positions in the image and a previous image, finding a new pixel value using a predetermined ratio; and
(d-2) if the absolute value of the difference between the pixel value of a corresponding position in the image and the new pixel value is smaller than a fourth threshold value, substituting and updating the pixel value of the corresponding position in the image with the new pixel value.

6. A device for filtering video noise adapted to filter noise of a plurality of images of a video stream, each image including a plurality of pixels, said device comprising:
a macroblock filtering unit for selecting an image, dividing the image into a plurality of macroblocks, each macroblock having a plurality of blocks, subsequently classifying the macroblocks into a plurality of smooth macroblocks and a plurality of noisy macroblocks, and outputting pixel values of the smooth macroblocks;
an edge/non-edge pixel classifying unit for classifying the pixels of each noisy macroblock into an edge pixel group and a non-edge pixel group; and
a filtering unit including a spatial vertical filter, a temporal filter, and a spatial horizontal filter, said non-edge pixel group being first directed to the processing of said spatial vertical filter and then to the processing of said temporal filter, the pixels yet to be outputted being processed by said spatial horizontal filter for subsequent output.

7. The device according to claim 6, wherein said macroblock filtering unit includes a first filter module which finds a range value of each block of the macroblocks, the range value of each block being the difference between a maximum pixel value and a minimum pixel value of the block, which subsequently finds a maximum range value of each macroblock according to the range values, and which finally determines whether the maximum range value is smaller than a predetermined first threshold value such that, if yes, the corresponding macroblock is classified as a smooth macroblock and the pixels thereof are outputted, and otherwise the corresponding macroblock is classified as a noisy macroblock.

8. The device according to claim 7, wherein said macroblock filtering unit further includes a second filter module for executing the following determinations:
if the maximum range value of each noisy macroblock is smaller than a predetermined second threshold value, soon directing the pixels of the respective noisy macroblock to the processing of said spatial horizontal filter; and
if the range value of any one block of the respective noisy macroblock is equal to the maximum range value of the respective noisy macroblock, soon directing the pixels of the respective block to the processing of said spatial horizontal filter.

9. The device according to claim 6, wherein said edge/non-edge pixel classifying unit includes:
a binarization module for finding a third threshold value according to a plurality of pixel values in each block, and for finding a binarization block corresponding to the respective block according to the pixel values and the third threshold value; and
a macroblock pixel selecting module which, by moving a sliding window of a predetermined size in the binarization block, finds an edge position in the respective block, and subsequently classifies the pixels at the edge position in the respective block into the edge pixel group, and the remaining pixels in the respective block into the non-edge pixel group.

10. The device according to claim 6, wherein said temporal filter is used to find a new pixel value according to a plurality of pixel values of corresponding positions in the image and a previous image using a predetermined ratio, and to subsequently substitute and update the pixel value of the corresponding position in the image with the new pixel value if the absolute value of the difference between the pixel value of the corresponding position in the image and the new pixel value is smaller than a fourth threshold value.

11. An integrated circuit for filtering video noise adapted to filter noise of a plurality of images of a video stream, each image including a plurality of pixels, said integrated circuit comprising:
a macroblock filtering unit for selecting an image, dividing the image into a plurality of macroblocks, each macroblock having a plurality of blocks, subsequently classifying the macroblocks into a plurality of smooth macroblocks and a plurality of noisy macroblocks, and outputting pixel values of the smooth macroblocks;
an edge/non-edge pixel classifying unit for classifying the pixels of each noisy macroblock into an edge pixel group and a non-edge pixel group; and
a filtering unit including a spatial vertical filter, a temporal filter, and a spatial horizontal filter, said non-edge pixel group being first directed to the processing of said spatial vertical filter and then to the processing of said temporal filter, the pixels yet to be outputted being processed by said spatial horizontal filter for subsequent output.

12. The integrated circuit according to claim 11, wherein said macroblock filtering unit includes a first filter module which finds a range value of each block of the macroblocks, the range value of each block being the difference between a maximum pixel value and a minimum pixel value of the block, which subsequently finds a maximum range value of each macroblock according to the range values, and which finally determines whether the maximum range value is smaller than a predetermined first threshold value such that, if yes, the corresponding macroblock is classified as a smooth macroblock and the pixels thereof are outputted, and otherwise the corresponding macroblock is classified as a noisy macroblock.

13. The integrated circuit according to claim 12, wherein said macroblock filtering unit further includes a second filter module for executing the following determinations:
if the maximum range value of each noisy macroblock is smaller than a predetermined second threshold value, soon directing the pixels of the respective noisy macroblock to the processing of said spatial horizontal filter; and
if the range value of any one block of the respective noisy macroblock is equal to the maximum range value of the respective noisy macroblock, soon directing the pixels of the respective block to the processing of said spatial horizontal filter.

14. The integrated circuit according to claim 11, wherein said edge/non-edge pixel classifying unit includes:
a binarization module for finding a third threshold value according to a plurality of pixel values in each block, and for finding a binarization block corresponding to the respective block according to the pixel values and the third threshold value; and
a macroblock pixel selecting module which, by moving a sliding window of a predetermined size in the binarization block, finds an edge position in the respective block, and subsequently classifies the pixels at the edge position in the respective block into the edge pixel group, and the remaining pixels in the respective block into the non-edge pixel group.

15. The integrated circuit according to claim 11, wherein said temporal filter is used to find a new pixel value according to a plurality of pixel values of corresponding positions in the image and a previous image using a predetermined ratio, and to subsequently substitute and update the pixel value of the corresponding position in the image with the new pixel value if the absolute value of the difference between the pixel value of the corresponding position in the image and the new pixel value is smaller than a fourth threshold value.

16. An encoder for filtering video noise adapted to filter noise and encode video, said encoder comprising:
an image input unit for receiving and inputting a video stream including a plurality of images, each image having a plurality of pixels;
a device for filtering video noise, which includes a macroblock filtering unit, an edge/non-edge pixel classifying unit, and a filtering unit, said macroblock filtering unit being used to divide an image into a plurality of macroblocks having a plurality of blocks, to subsequently classify the macroblocks into a plurality of smooth macroblocks and a plurality of noisy macroblocks, and to output pixel values of the smooth macroblocks, said edge/non-edge pixel classifying unit being used to classify the pixels of each noisy macroblock into an edge pixel group and a non-edge pixel group, said filtering unit having a spatial vertical filter, a temporal filter, and a spatial horizontal filter, said non-edge pixel group being first directed to the processing of said spatial vertical filter and then to the processing of said temporal filter, the pixels yet to be outputted being processed by said spatial horizontal filter for subsequent output;
a memory unit for temporarily storing the macroblocks outputted by said device for filtering video noise; and
a video encoding unit for reading and encoding the macroblocks temporarily stored in said memory unit.

17. The encoder according to claim 16, wherein said macroblock filtering unit includes a first filter module which finds a range value of each block of the macroblocks, the range value of each block being the difference between a maximum pixel value and a minimum pixel value of the block, which subsequently finds a maximum range value of each macroblock according to the range values, and which finally determines whether the maximum range value is smaller than a predetermined first threshold value such that, if yes, the corresponding macroblock is classified as a smooth macroblock and the pixels thereof are outputted, and otherwise the corresponding macroblock is classified as a noisy macroblock.

18. The encoder according to claim 17, wherein said macroblock filtering unit further includes a second filter module for executing the following determinations:
if the maximum range value of each noisy macroblock is smaller than a predetermined second threshold value, soon directing the pixels of the respective noisy macroblock to the processing of said spatial horizontal filter; and
if the range value of any one block of the respective noisy macroblock is equal to the maximum range value of the respective noisy macroblock, soon directing the pixels of the respective block to the processing of said spatial horizontal filter.

19. The encoder according to claim 16, wherein said edge/non-edge pixel classifying unit includes:
a binarization module for finding a third threshold value according to a plurality of pixel values in each block, and for finding a binarization block corresponding to the respective block according to the pixel values and the third threshold value; and
a macroblock pixel selecting module which, by moving a sliding window of a predetermined size in the binarization block, finds an edge position in the respective block, and subsequently classifies the pixels at the edge position in the respective block into the edge pixel group, and the remaining pixels in the respective block into the non-edge pixel group.

20. The encoder according to claim 16, wherein said temporal filter is used to find a new pixel value according to a plurality of pixel values of corresponding positions in the image and a previous image using a predetermined ratio, and to subsequently substitute and update the pixel value of the corresponding position in the image with the new pixel value if the absolute value of the difference between the pixel value of the corresponding position in the image and the new pixel value is smaller than a fourth threshold value.
